(19) United States
(12) Patent Application Publication
(10) Pub. No.: US 2026/0227884 A1
(43) Pub. Date: Aug. 6, 2026

(54) Methods and Systems for Generating Visual Representations of Routine Events

(71) Applicant: Mllnnl, LLC, Astoria, NY (US)

(72) Inventor: David Yarus, Miami Beach, FL (US)

(21) Appl. No.: 19/044,822

(22) Filed: Feb. 4, 2025

(51) Int. Cl. G06F 3/0482

(52) U.S. Cl. CPC G06F 3/0482

(57) ABSTRACT

Embodiments generate visual representations of routine events. A data structure in computer memory stores a plurality of entries, each entry corresponding to a routine event and including a cadence and a record of occurrence. A graphical user interface (GUI) is rendered based on the plurality of entries stored, wherein the rendering includes: (i) identifying a subset of the plurality of entries, (ii) rendering at least one ring based on the subset identified, each ring associated with a ring cadence, and (iii) rendering an indicator for each entry of the subset on a ring based on the ring cadence, the cadence of the entry, and the record of occurrence. A position of the indicator on the ring is a function of the record of occurrence and the cadence. The rendering of the GUI provides a visual representation of routine events. Embodiments may provide an intuitive interface for managing the routine events.

### BACKGROUND

Routine events, including as non-limiting examples connecting with people, leisure activities, medical appointments, continued learning, and automobile maintenance, may constitute a substantial and important part of a person's schedule. However, managing these events, e.g., tasks that occur at routine but disparate intervals, may be challenging. Tools that assist with the management of tasks or routine events have become increasingly commonplace as a result.

### SUMMARY

Existing methods assisting with the management of such routine tasks may include physical or electronic calendar-and text-based reminders. However, these existing methods lack an automatically updating visual interface, e.g., graphical user interface (GUI), that intuitively communicates the imminency of a plurality of routine events. Embodiments disclosed herein provide such functionalities.

An example embodiment is directed to a computer-implemented method for generating visual representations of routine events. The method includes storing a plurality of entries in a data structure in computer memory. Each entry of the plurality of entries corresponds to a routine event and includes a cadence and a record of occurrence. The method further includes rendering a GUI based on the plurality of entries stored. The rendering includes: (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry. The position of the indicator on the ring is a function of the record of occurrence and the cadence. The rendering of the GUI provides a visual representation of routine events.

In some embodiments, the method further includes receiving a given entry of the plurality of entries from a user. In other embodiments, the method includes retrieving automatically a given entry of the plurality of entries by communicating with a software applicating, e.g., using an application programming interface (API).

In some embodiments, the method further includes prompting a user to perform a given routine event based on the cadence and the record of occurrence included in a given entry of a plurality of entries. In such an embodiment, the given entry corresponds to the given event.

In some embodiments, the method includes receiving from a user an indication of an occurrence of a given event corresponding to a given entry of the subset of the plurality of entries. The method, according to such an embodiment, may further include updating the record of occurrence included in the given entry. In further embodiments, the method includes modifying the position of the indicator for the given entry in the GUI based on the updated record of occurrence.

In an embodiment, the method includes identifying automatically an indication of occurrence of a given event corresponding to a given entry of the subset of the plurality of entries by communicating with a software application, e.g., using an application programming interface. The record of occurrence included in the given entry may, in turn, be updated.

In some embodiments, the method includes identifying a delinquent entry of the plurality of entries based on the record of occurrence and the cadence included in the delinquent entry. The method may also render a visual marker, i.e., indication, for the delinquent entry in the GUI.

In some embodiments, the method includes rendering a graphical list based on the subset of the plurality of entries. An order of the subset of the plurality of entries in the graphical list may be a function of the record of occurrence and the cadence of each entry of the subset.

In other embodiments, the method includes rendering a symbol of a user within a circumference of the at least one ring.

In some embodiments, the routine events include at least one of contacting an individual and performing an activity. In alternative embodiments, for a given entry of the plurality of entries, the cadence included is a length of time.

In some embodiments, the at least one ring includes at least two rings. In such an embodiment, the rendering the at least one ring may include rendering a first ring of the at least two rings with a smaller radius to indicate a shorter ring cadence and rendering at least a second ring of the at least two rings to indicate a longer ring cadence. In yet another embodiment, rendering the at least one ring includes rendering a first ring of the at least two rings and at least a second ring of the at least two rings concentrically.

In some embodiments, a given entry of the plurality of entries includes further information. According to an embodiment, the further information includes an entry location and such an embodiment includes retrieving automatically a location of a user by communicating with a software application, e.g., using an application programming interface. The method further includes notifying the user of a spatial proximity to the given entry based on the location of the user and the entry location of the given entry or rendering a graphic representation in the GUI of the spatial proximity.

In yet another embodiment, the further information includes temporal information and the method includes notifying a user of a temporal proximity to the temporal information of the given entry based on a current date and the temporal information or providing a graphical representation of the temporal proximity.

Another example embodiment is directed toward a computer-based system for generating visual representations of routine events. The system includes a display, a processor, and a memory with computer code instructions stored thereon. The processor and the memory, with the computer code instructions, is configured to cause the computer-based system to store a plurality of entries in a data structure in the memory. Each entry of the plurality of entries corresponds to a routine event and includes a cadence and a record of occurrence. The processor and the memory is further configured to cause the computer-based system to render, on the display, a GUI based on the plurality of entries. The rendering includes (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry. The position of the indicator on the ring is a function of the record of occurrence and the cadence. The rendering of the GUI provides a visual representation of routine events.

Still another example embodiment is directed toward a computer program product for generating visual representations of routine events. The computer program product includes a non-transitory computer-readable medium with computer code instructions stored thereon. The computer code instructions are configured, when executed by a processor, to cause an apparatus associated with the processor to store a plurality of entries in a data structure in the memory. Each entry of the plurality of entries corresponds to a routine event and includes a cadence and a record of occurrence. The computer code instructions are further configured to cause the apparatus to render, on a display, a GUI based on the plurality of entries. The rendering includes (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry. The position of the indicator on the ring is a function of the record of occurrence and the cadence. The rendering of the GUI provides a visual representation of routine events.

It is noted that embodiments of the method, system, and computer program product may be configured to implement any embodiments, or combination of embodiments, described herein.

### DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic illustration of an example embodiment of a computer-implemented method for generating visual representations of routine events.

FIGS. 2A and 2B illustrate example GUIs for onboarding new users that may be used by embodiments.

FIGS. 3A and 3B illustrate example GUIs for user account creation that may be used by embodiments.

FIGS. 4A and 4B illustrate example GUIs prompting a user to provide contact information for routinely contacted individuals that be used by an embodiment.

FIGS. 5A and 5B illustrate example GUIs for inputting an entry that may be used by embodiments.

FIG. 6 illustrates an example GUI with a prompt for providing permission for users to receive notifications that may be used by embodiments.

FIGS. 7A-7E are example GUIs, which may be used by an embodiment, illustrating a position of an indicator for a given entry.

FIGS. 8A-8C illustrate example GUIs, which may be implemented by embodiment to render a subset of entries.

FIGS. 9A-9C illustrate example GUIs, which may be provided by an embodiments.

FIGS. 10A and 10B illustrate example GUIs rendered by an embodiment to provide indicators associated entries.

FIG. 11 illustrates an example GUI including a menu for filtering a subset of entries that may be used by an embodiment.

FIGS. 12A and 12B illustrate example GUIs for managing a given entry according to an embodiment.

FIGS. 13A-13D illustrate example GUIs for querying for additional information that may be implemented by embodiments.

FIGS. 14A-14C illustrate example GUIs, according to an embodiment, for querying location information.

FIGS. 15A-15C illustrate example GUIs indicating entries within a spatial proximity of a user based on the location information queried in FIGS. 14A-14C.

FIGS. 16A-16E illustrate example GUIs of a graphical list including indicators for a subset of entries provided by an embodiment.

FIGS. 17A-17C illustrate example GUIs for managing settings, according to an embodiment.

FIGS. 18A and 18B illustrate example GUIs that include functionality for communicating between a user and a given entry, according to an embodiment.

FIG. 19 is a flowchart of a method for generating visual representations of routine events according to an embodiment.

FIG. 20 illustrates a computer network or similar digital processing environment in which embodiments may be implemented.

FIG. 21 is a diagram illustrating an example internal structure of a computer in the environment of FIG. 20.

### DETAILED DESCRIPTION

A description of example embodiments follows.

As noted above, managing tasks, e.g., events, is challenging and, as such, tools that assist with the management of events have become increasingly commonplace. Amongst other examples, existing methods include computer-based calendar and reminder systems. However, even these existing computer-based methods are inadequate. Amongst other deficiencies, these existing methods do not provide automatically updating visual interfaces that indicate tasks/events and these existing methods do not facilitate the automatic management and performance of tasks/events. Embodiments solve these problems.

Embodiments may assist in keeping in touch with people or in maintaining routine habits or activities. In an embodiment, each person or activity is recorded as an entry in a data structure. Embodiments are built around a foundational concept of “Orbit Rings,” including at least one ring or circle, which may be concentric. The “Orbit Rings” represent different intervals or ring cadences. For example, “orbit rings” may represent intervals of time such as weekly, monthly, quarterly, and annually. The rings may be rendered in graphical user interfaces (GUIs) and serve as a tool for organizing and visualizing desired cadences, time elapsed, and which entries are in each orbit, i.e., which entries are performed/occur with which particular cadence.

Embodiments may be configured to receive an entry from a user. Entries may include at least a cadence, i.e., an indication of entry frequency, and a record of occurrence, i.e., an indication of when an entry was performed. Users may also provide additional information, including a relationship to the user, a birthday of a person, or a location, amongst other examples. Embodiments may be configured to store entries in a data structure in computer memory and to render indicators of entries in a GUI in association with a ring with a ring cadence corresponding to cadence(s) of the entries. Example indicators may include an image of an entry and an initial. The embodiments may be further configured to store a plurality of entries.

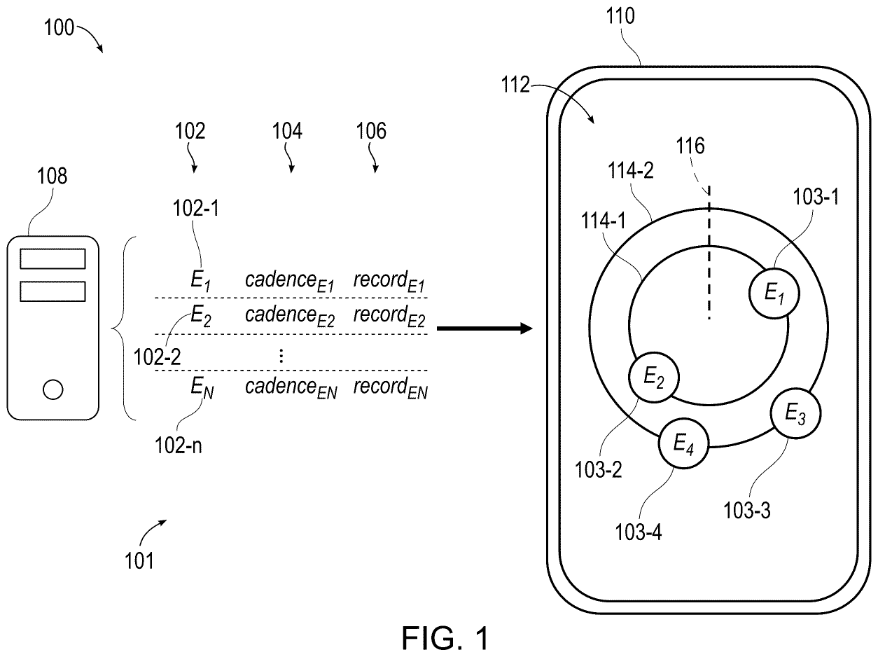

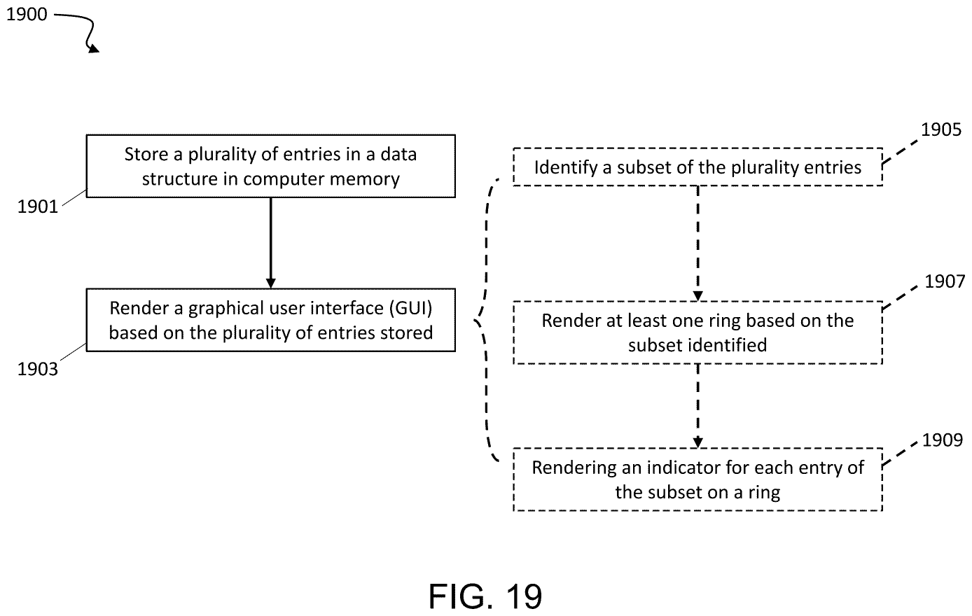

FIG. 1 is a schematic illustration of an example embodiment of a computer-implemented method 100 for generating visual representations of routine events. The computer-implemented method 100 may be similar to the method of flowchart 1900 described herein in relation to FIG. 19 and provides graphical representation of elements for generating visual representations of routine events. According to an embodiment, example routine events include communicating with a person or engaging in an activity on a regular or semi-regular basis. The method includes storing a plurality of entries 102 in a data structure 101 in computer memory of the computing device 108. Each entry, for example, entries 102-1, 102-2, 102-n, of the plurality of entries correspond to a respective routine event and include a cadence 104 and a record of occurrence 106. The method further includes rendering a graphical user interface 112 based on the plurality of entries 102 stored. A graphical user interface 112 may be rendered on a display of an electronic device 110, for example, a phone or a computer. The rendering includes: (i) identifying a subset of the plurality of entries 102, (ii) rendering at least one ring 114-1, 114-2 based on the subset identified, each ring associated with a ring cadence, and (iii) rendering an indicator 103-1, 103-2, 103-3, 103-4 for each entry of the subset on a ring of the at least one ring 114-1, 114-2 based on the ring cadence of the ring, the cadence 104 of the entry, and the record of occurrence 106 of the entry. The position of the indicator 103-1, 103-2, 103-3, 103-4 on the ring of the at least one ring 114-1, 114-2 is a function of the record of occurrence 106 and the cadence 104 of the entry. In this way, the rendering of the GUI 112 provides a visual representation of routine events. Moreover, the GUI 112 may include a start point 116 that represents a point of origin of the indicator 103-1,103-2,103-3, 103-4 along the respective rings of the at least one ring 114-1, 114-2.

Some embodiments of the present invention may include software applications. User engagement with these embodiments may begin by downloading a software application from a respective application distribution portal. Launching the downloaded software application may initiate an onboarding process that explains the purpose and functionalities of the software application.

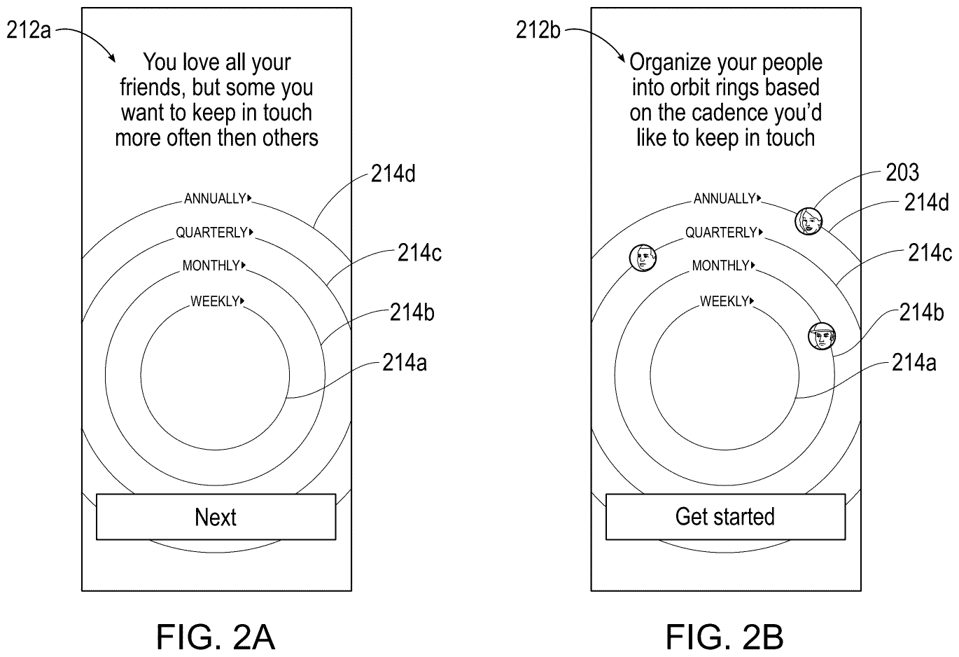

FIGS. 2A and 2B illustrate example GUIs 212a, 212b for onboarding new users that may be used by an embodiment. As described herein in relation to the rendering 1907 at least one ring of FIG. 19, GUI 212a of FIG. 2A includes rendering of rings 214a-d associated with cadences, specifically cadences of weekly 214a, monthly 214b, quarterly 214c, and annually 214d. GUI 212a further explains categorization of contacts into respective cadences. GUI 212b of FIG. 2B includes rendering of the rings 214a-d and, additionally, GUI 212b includes rendering of indicators, e.g., 203, of entries corresponding to events as described herein in relation to the rendering 1909 the indicator of FIG. 19. In the example of FIG. 2B, the routine events are contacting people at routine but varied intervals and, thus, the indicators, e.g., 203, are images of the people to contact. Each indicator, e.g., 203, is rendered on a ring based on a cadence of the given entry and the cadence of the ring itself. In the example of FIG. 2B, the person represented by indicator 203 is supposed to be contacted annually (i.e., the cadence of the entry is annually) and, thus, the indicator 203 is rendered on the ring 214d (i.e., the ring with an annual ring cadence).

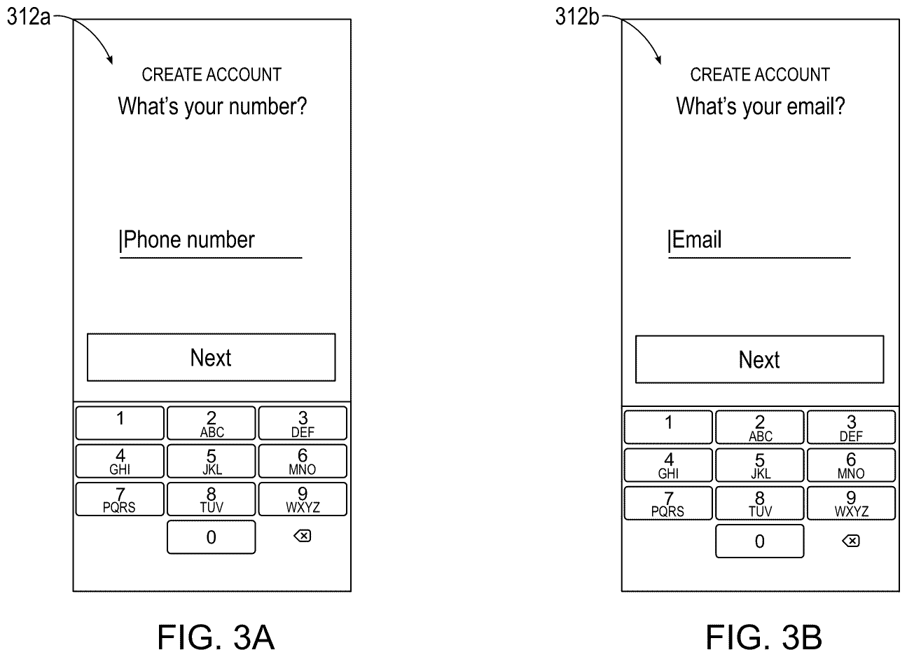

FIGS. 3A and 3B illustrate example GUIs 312a, 312b for user account creation that may be implemented embodiments. The GUIs 312a, 312b may be presented to a user during an account creation step of an onboarding process. GUI 312a of FIG. 3A queries from the user a phone number to be associated with an account and GUI 312b of FIG. 3B queries from the user an email address to be associated with the account. Said phone number and email address may be stored in memory, e.g., associated in a data structure as corresponding to a particular user.

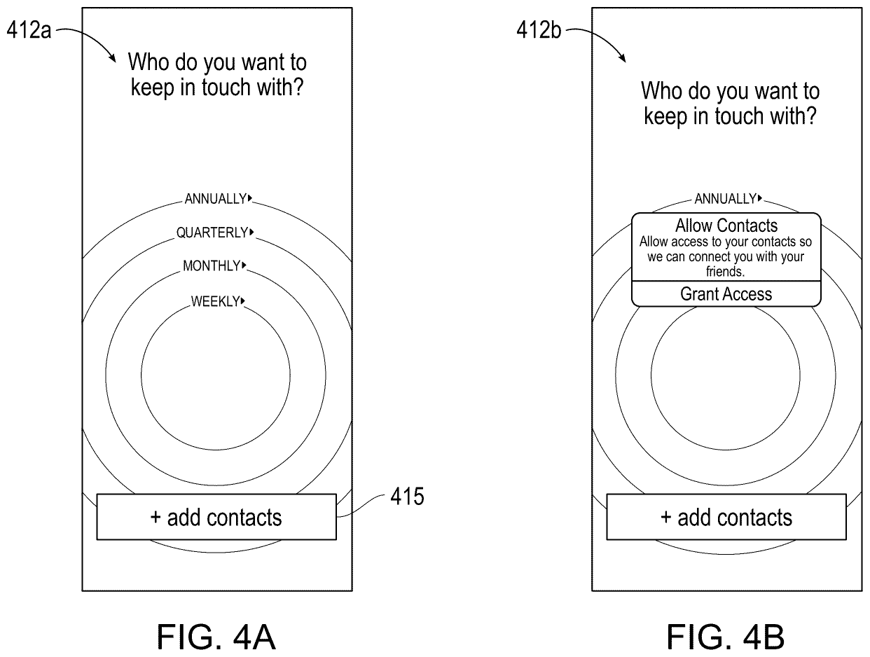

FIGS. 4A and 4B illustrate example GUIs 412a, 412b prompting a user to provide contact information for routinely contacted individuals that may be implemented by an embodiment. FIG. 4A illustrates a GUI 412a rendered with an add button 415 to add contacts. The embodiment may be configured to receive a contact from a user, such as through manual entry, or to automatically retrieve the contact from another software application, e.g., an existing contact management application on a computing device. FIG. 4B illustrates a GUI 412b rendered with a prompt to enable the embodiment to access a contacts application. The embodiment may retrieve automatically a contact by communicating with a software application, for example, the contacts application, that includes contacts of the user using an application programming interface. Added contacts may be stored in a manner similar to the entries 102 of FIG. 1.

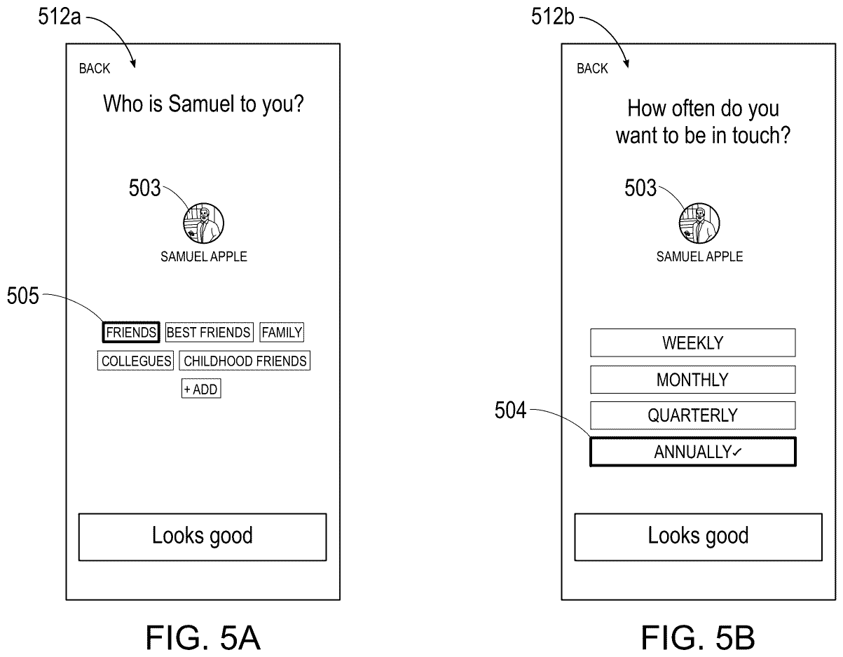

FIGS. 5A and 5B illustrate example GUIs 512a, 512b for inputting an entry that may be used by an embodiment. FIG. 5A illustrates a GUI 512a rendered with an indicator 503 of a contact or entry. The GUI 512a queries a user for information regarding the relation between the contact or entry and the user. In the GUI 512a, the relation between the user and entry (associated with indicator 503) is selected to be friend 505. FIG. 5B illustrates a GUI 512b rendered with the indicator 503. The GUI 512b queries the user for information regarding the desired cadence or interval for communicating with the contact or entry. In the GUI 512b, the desired cadence is selected to be annually 504.

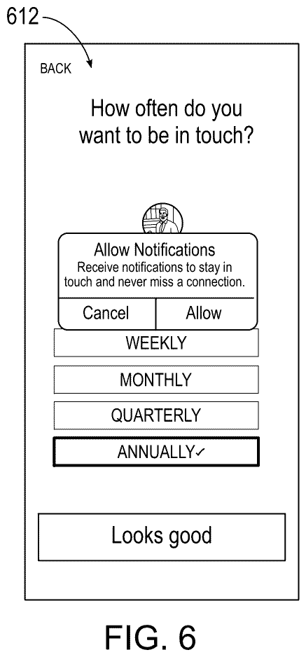

FIG. 6 illustrates an example GUI 612 with a prompt for providing permission for users to receive notifications that may be used by an embodiment.

FIGS. 2A-B, 3A-B, 4A-B, 5A-B, and 6 collectively illustrate elements of an onboarding process that may be used by embodiments. After the onboarding process, a user may utilize the full functionalities of the embodiments. Moreover specifically, FIGS. 2A-B, 3A-B, 4A-B, 5A-B, and 6 illustrate a process for creating an account and providing information to an embodiment to allow such an embodiment to generate visual representations of routine events. The examples illustrated across FIGS. 2A-B, 3A-B, 4A-B, 5A-B, and 6 pertain to an example where the routine events are contacting individuals. However, it is noted that embodiments are limited to such an example, and embodiments may be implemented to generate visual representations of any routine events. Further, embodiments may store the information provided via interfaces, e.g., the GUIs 312a, 312b, 412a, 412b, 512a, and 512b, into memory. For instance, as described herein with relation to the storing 1901 the plurality of entries of FIG. 19, the entry associated with indicator 503 may be stored along with the relationship 505 and desired cadence 504 in a data structure, e.g., 101 (FIG. 1).

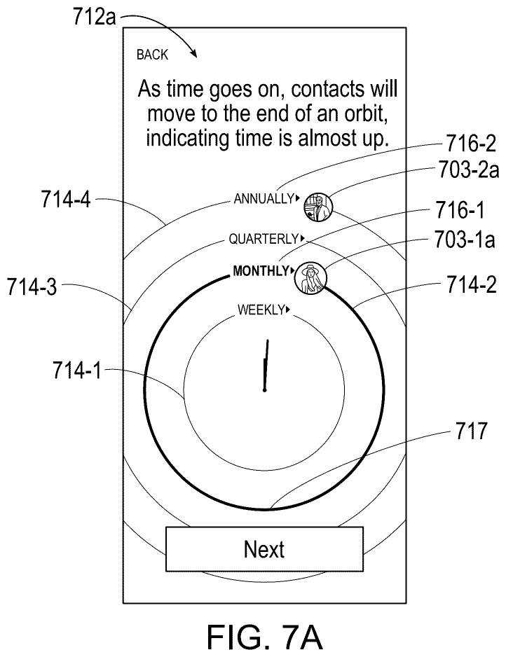

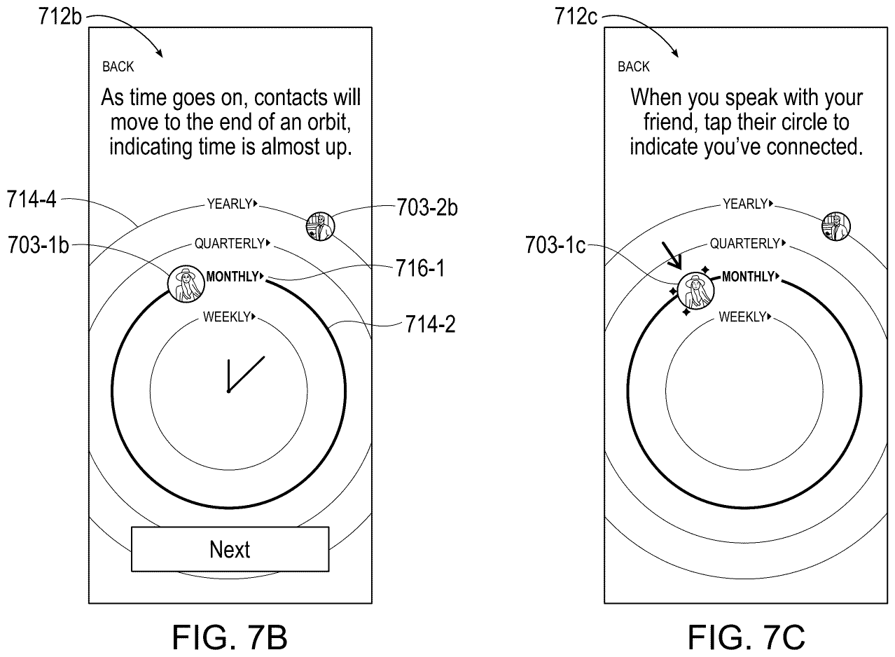

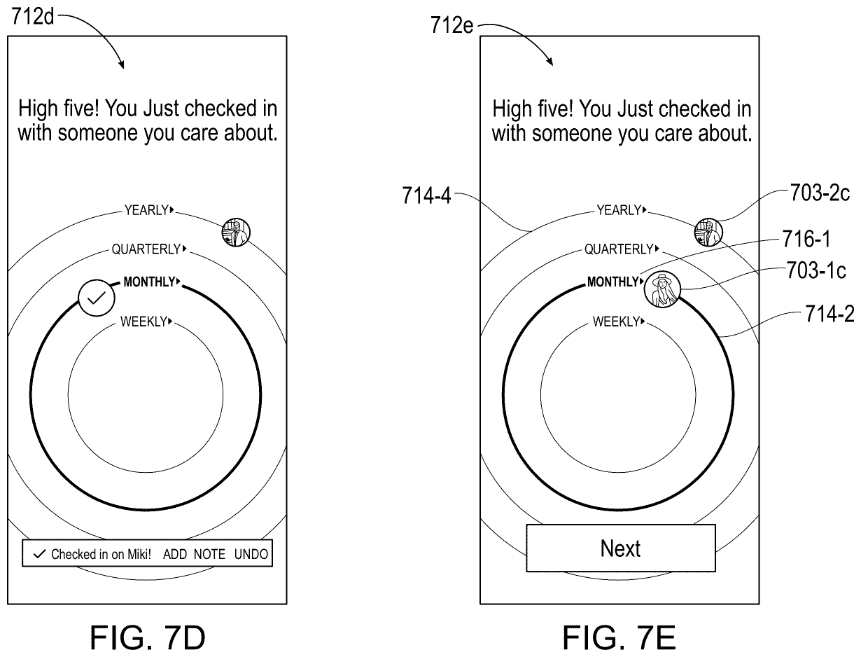

FIGS. 7A-7E are example GUIs 712a, 712b, 712c, 712d, 712e, respectively, which may be rendered by embodiments. GUIs 712a-e illustrate functionality of an embodiment where position of an indicator for a given entry on a corresponding ring is a function of a cadence and a record of occurrence of the entry. As described herein in relation to FIG. 19, the method 1900 includes (ii) rendering 1907 at least one ring and (iii) rendering 1909 an indicator of each entry of the subset on a ring. Similarly, FIG. 7A illustrates a GUI 712a that includes rings 714-1, 714-2, 714-3, and 714-4. Each ring (714-1, 714-2, 714-3, and 714-4) has an associated ring cadence, i.e., each ring pertains to a particular period of time. In the GUI 712a, the ring 714-1 has a weekly ring cadence, the ring 714-2 has a monthly ring cadence, the ring 714-3 has a quarterly ring cadence, and the ring 714-4 has an annually ring cadence. The GUI 712a also includes an indicator 703-1a, and an indicator 703-2a. The indicator 703-1a and the indicator 703-2a correspond with a first entry and a second entry, respectively, of a plurality of entries, which may be similar to the plurality of entries 102 of FIG. 1. The first entry (corresponding to indicator 703-1a) includes a cadence of a monthly interval; correspondingly, the indicator 703-1a is rendered on the ring 714-2 because the ring 714-2 has a monthly ring cadence. Similarly, the second entry includes a cadence of a yearly interval; the indicator 703-2a is rendered on the ring 714-4 because the ring 714-4 has a yearly ring cadence. FIG. 7A further illustrates that, in an embodiment, an indicator, e.g., 703-1a and 703-2a, will travel along an orbit, for example, a ring, based on the cadence of the respective entry and a record of occurrence of the respective entry. Restated, position of an indicator on a ring will vary based upon a record of when an event corresponding to the indicator most recently occurred. To illustrate using the example of the GUI 712a, position of the indicator 703-1a will progress along the ring 714-2, for example, in a counterclockwise path along the ring 714-2 from a start point 716 of the ring 714-2, based on a time elapsed from a record of occurrence of the first entry. In this example, indicator 703-1a is in close proximity to the start point 716 and, thus, a small amount of time has elapsed since contact with the person associated with indicator 703-1a last occurred. To further illustrate, if, however, contact with the person associated with indicator 703-1a last occurred approximately 15 days ago, indicator 703-1a would be at approximately the half-way position 717 on ring 714-2. The indicator 703-2a is rendered along the ring 714-4 in a similar fashion. In GUI 712a, the indicators 703-1a and 703-2a are rendered close to the start points 716-1 and 716-2, respectively, indicating short elapsed times with respect to respective records of occurrence of the first entry and the second entry.

FIG. 7B illustrates a GUI 712b similar to the GUI 712a, but wherein a period of time has elapsed. Correspondingly, the GUI 712b is rendered with updated positions for the indicator 703-1b and the indicator 703-2b. Specifically, the GUI 712b is rendered to indicate an elapsed period of approximately one month in comparison to the GUI 712a. The indicator 703-1b, associated with the first entry, has nearly completed a full orbit from a start point 716-1 around the ring 714-2, indicating the elapsed period is approaching the cadence (monthly) of the first entry with respect to the record of occurrence. The indicator 703-2b is similarly rendered in a different position along the ring 714-4. The position of the indicator 703-2b on the ring 714-4 is approximately one-twelfth around the circumference of the ring 714-4. In this way, the position of the indicator 703-2b reflects a distanced traveled corresponding to a fraction of time elapsed with respect to the cadence of the ring 714-4.

FIG. 7C illustrates a GUI 712c rendered to instruct a user to provide an indication of connecting with an entry (i.e., performing a routine event) by interacting, for example, tapping, on an indicator 703-1c of the entry.

FIG. 7D illustrates a GUI 712d rendered to further instruct the user regarding visual feedback of successfully providing the indication. According to an embodiment, successfully providing the indication of connecting with the entry updates a record of occurrence of the entry.

FIG. 7E illustrates a GUI 712e similar to the GUIs 712a-b, but wherein an indication of connecting with an entry has been provided. Specifically, a user has connected with an entry. Responsively, the record of occurrence of the entry is updated and a position rendered of the indicator 703-1c (associated with the entry) on the ring 714-2 is updated. Time elapsed with respect to the updated record of occurrence is small and the indicator 703-1c is positioned close to the start point 716-1 in a counterclockwise direction. Meanwhile, position of the indicator 703-2c on the ring 714-4 remains unchanged with respect to the second indicator 703-2b of FIG. 2B as the entry associated with the indicator 703-2b has not been updated (i.e., no contact has occurred) and no time has elapsed between the GUIs 712b and 712e.

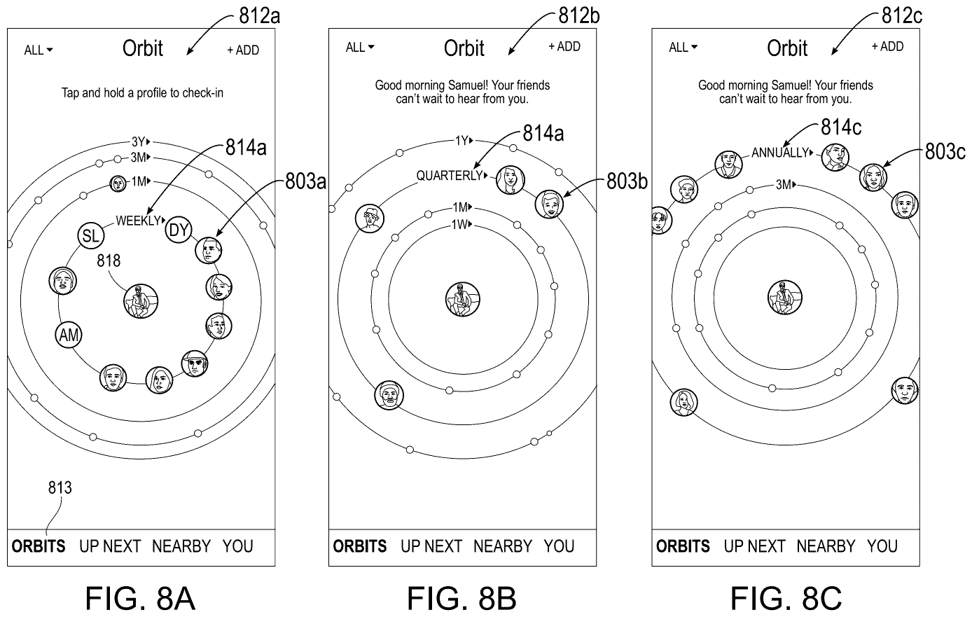

FIGS. 8A-8C illustrate example GUIs 812a, 812b, 812c, respectively, which may be rendered by an embodiment for a subset of entries associated with a given ring. As described herein in relation to FIG. 19, rendering 1903 a GUI based on the plurality of entries stored includes identifying 1905 a subset of the plurality of entries. GUI 812a of FIG. 8A illustrates a rendered ring 814a. The ring 814a is a weekly ring (i.e., a ring with a ring cadence of weekly). In the GUI 812a, a user has selected a subset of a plurality of entries for rendering wherein each entry of the subset has the same cadence, namely weekly. Indicators, e.g., 803a, are rendered for each entry of the subset in GUI 812a. Further, the GUI 812a includes a user indicator 818, which may be a photo or an icon representative of a user, and a tabulated menu 813 that enables toggling between different rendered interfaces. The “ORBITS” interface is selected in the tabulated menu 813. In an embodiment, different subsets are selected using the menu 813.

FIG. 8B illustrates a GUI 812b with a ring 814b. In the GUI 812b, the ring 814b (i.e., the ring with a ring cadence of quarterly) is selected for rendering. A corresponding subset of a plurality of entries is identified responsive to the user selecting the quarterly ring 814b for rendering and indicators, e.g., 803b, are rendered for each entry of the corresponding subset. FIG. 8C illustrates a GUI 812c with a ring 814c. In the GUI 812c, the ring 814c (i.e., the ring with a ring cadence of annually) is selected for rendering. Entries corresponding to the selected ring 814c are identified (i.e., entries with an annual cadence) and indicators, e.g., 803c, corresponding to the identified entries are rendered on the ring 814c.

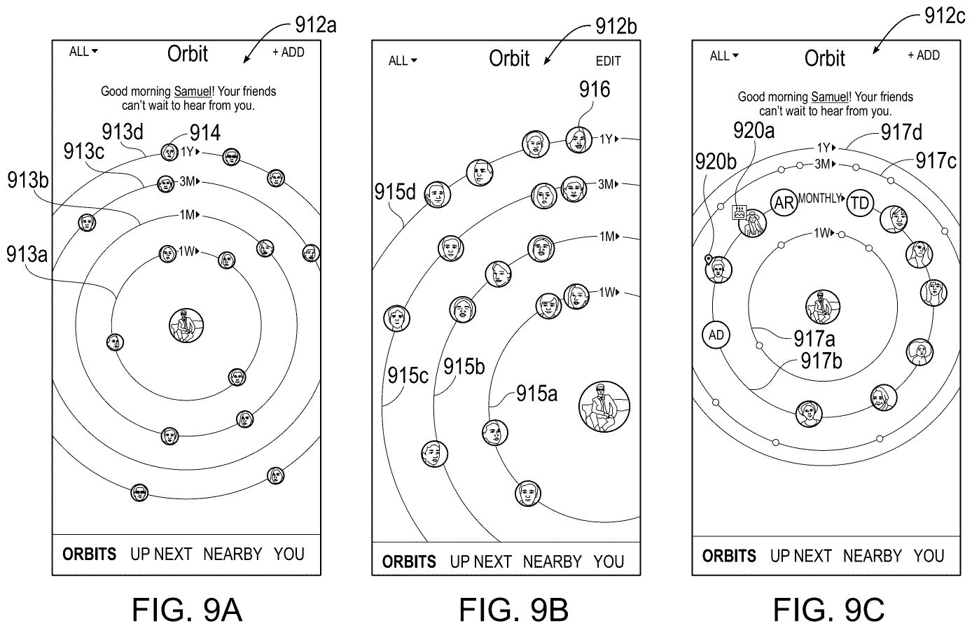

FIGS. 9A-9C illustrate example GUIs 912a, 912b, 912c, respectively, which may be rendered by embodiments, as described herein in relation to the rendering 1903 a GUI based on the plurality of entries stored of FIG. 19. Furthermore, users may interact with GUIs rendered, for example, using electronic input devices or a touch screen, to manipulate rendering of the GUIs. FIGS. 9A-9C show changes in GUIs that may result from user interactions. FIG. 9A illustrates a GUI 912a rendered with a full view of each ring 913a-d and indicators, e.g., 914. FIG. 9B illustrates a GUI 912b rendered with a partial, zoomed-in view of rings 915a-d and indicators, e.g., 916. FIG. 9C illustrates a GUI 912c rendered with a full view of rings 917a-d and focus on indicators of the ring 917b (the ring with a monthly ring cadence. Further, GUI 912c includes notification indicators 920a-b rendered to notify a user of additional information of particular entries. The additional information may include an imminent birthday 920a or spatial proximity 920b and the notification indicators may be graphic representations of the additional information, e.g., a cake 920a for a birthday or a pin 920b for a location.

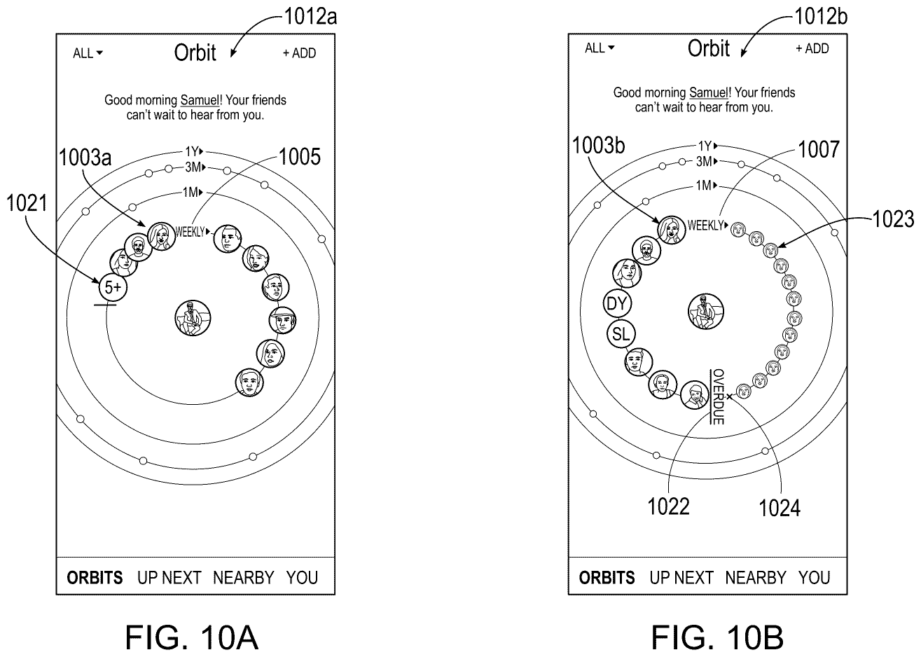

FIGS. 10A and 10B illustrate example GUIs 1012a, 1012b, respectively, which may be rendered by embodiments with collapsible or delinquent indicators entries. FIG. 10A illustrates a GUI 1012a rendered with a view of the ring 1005 (with a weekly ring cadence) and indicators, e.g., 1003a, on the ring 1005 where the indicators are associated with entries with a weekly cadence. In the GUI 1012a a hidden portion of the indicators are collapsed and hidden from view, as indicated by collapsed indicator 1021. Collapsing the hidden portion of the indicators may improve visibility of a rendered portion of the indicators. The collapsed indicator 1021 may include an indication of a number of the indicators that are hidden.

FIG. 10B illustrates a GUI 1012b rendered with a view of the ring 1007 and a focus on indicators, e.g., 1003b, of the ring 1007. The GUI 1012b shows an expanded view of collapsed indicators, for example, as indicated by collapsed indicator 1021 of FIG. 10A. The expanded view of the GUI 1012b may be opened by interacting with the collapsed indicator 1021 and closed by interacting with a close symbol 1024.

Additionally, the GUI 1012b is rendered to illustrate delinquent entries, which may be identified based on a cadence and respective records of occurrence associated with the delinquent entries. If a metric, for example, a time elapsed, with respect to the record of occurrence exceeds the cadence, the given entry may be identified as delinquent. The GUI 1012b is rendered with delinquent indicators, e.g., 1023 representative of the delinquent entries. Furthermore, the GUI 1012b is rendered to show the delinquent indicators 1023 in the expanded view, as indicated by the overdue divider 1022, which is adjacent to the close symbol 1024. Toggling the close symbol 1024 may collapse and hide the delinquent indicators 1023.

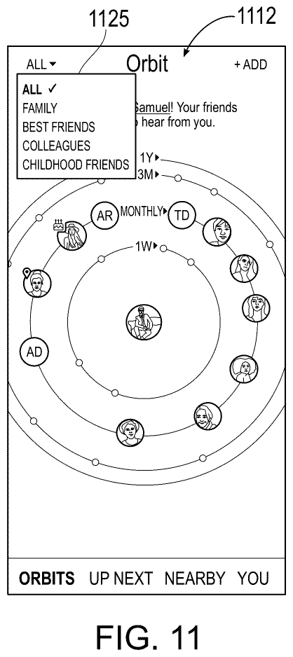

FIG. 11 illustrates an example GUI 1112 including a menu 1125 for filtering a subset of entries according to an embodiment. In addition to selecting a subset of entries as described hereinabove in relation to FIGS. 8A-8C, a subset of a plurality of entries may be identified based on other categories. As illustrated in the GUI 512a and described hereinabove in relation to FIG. 5A, entries may include a relation to a user or other information. The GUI 1112 is rendered with a filter menu 1125 configured to allow a user to select a subset of entries for rendering based on information associated with the entries, e.g., the relation of the entries to the user.

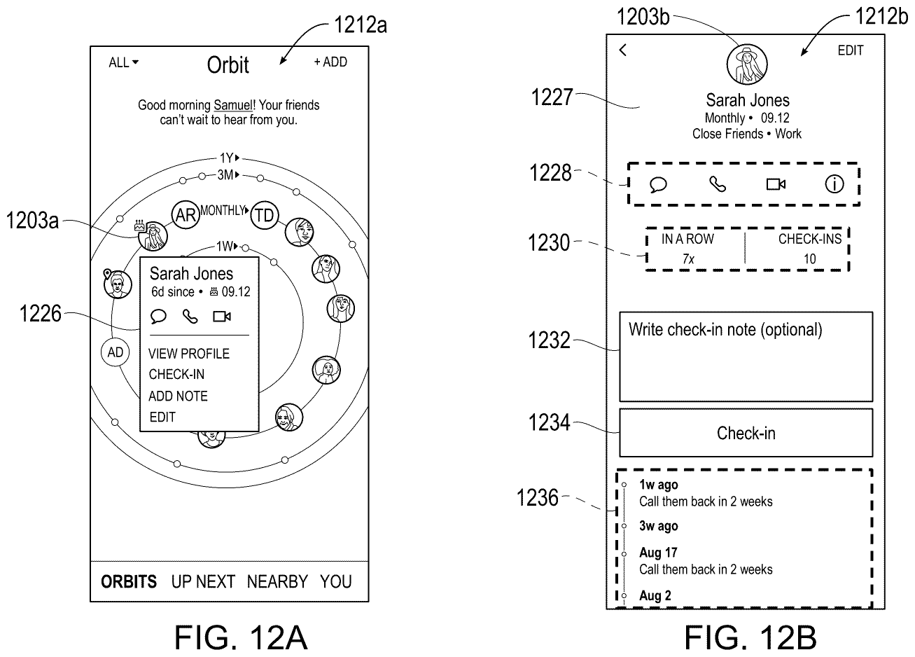

FIGS. 12A and 12B illustrate example GUIs 1212a, 1212b, respectively, which may be rendered by an embodiment, for managing a given entry. FIG. 12A illustrates a GUI 1212a wherein a user has interacted with an indicator 1203a of the given entry. Responsive to the interaction, an entry menu 1226 for the given entry is provided. The entry menu 1226 including options to contact the person associated with the given entry, for example, by text message, phone call, or video call. Further selection of one of the options in the menu 1226 responsively causes a native application on a computing device implementing the embodiment to perform the selected option, e.g., messaging or calling. The entry menu 1226 may also include options to, for the given entry, view the given entry, provide a manual check-in to update a record of occurrence, add a note, or edit the given entry.

FIG. 12B illustrates a GUI 1212b rendered to show an entry page 1227 of the given entry. The entry page 1227 includes an indicator 1203b of the given entry, contact options 1228 to contact the given entry, and a counter 1230b of check-ins with the given entry. The GUI 1212b further includes a text box 1232, a check-in button 1234 for receiving manual indication of checking in with the given entry, and a history 1236 recording previous instances of check-ins with the given entry.

The GUI 1212b provides functionality for recording a note regarding the given entry using the text box 1232. The note may be included in the history 1236 of the entry page 1227 of the given entry.

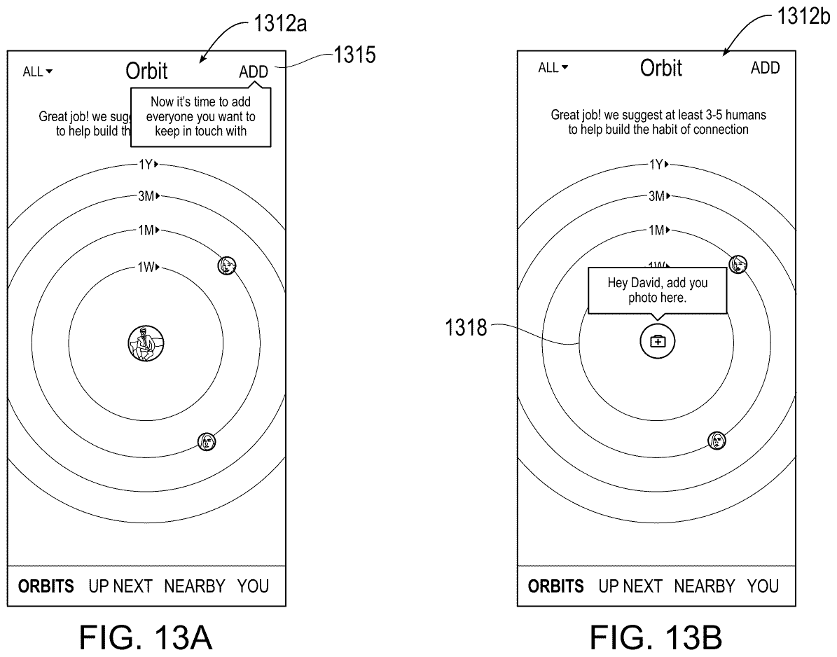

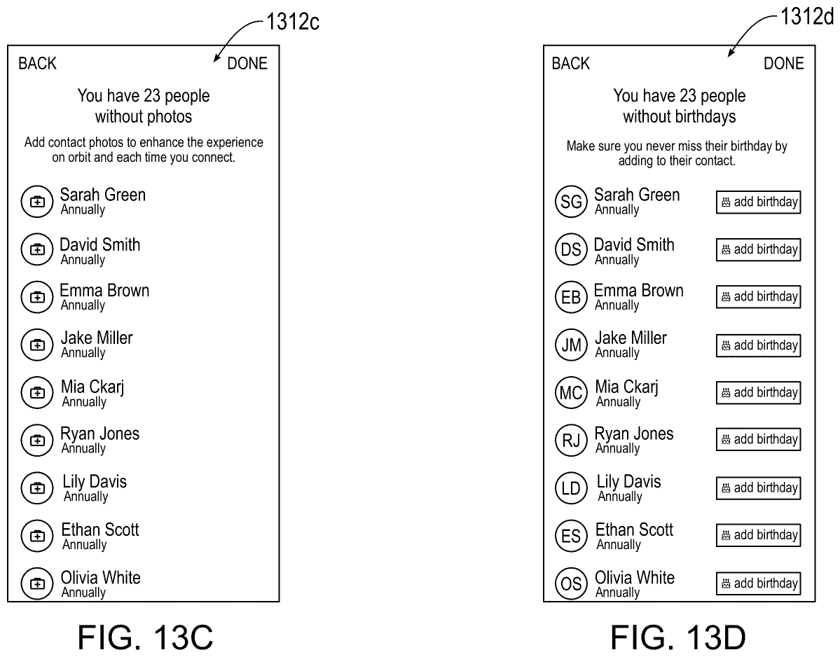

FIGS. 13A-13D illustrate example GUIs 1312a, 1312b, 1312c, 1312d, respectively, which may be implemented by an embodiment to query a user for additional information regarding entries or the user. Generally, the example GUIs 1312a-d may be instructive regarding how to use embodiments and may be helpful for requesting information not previously provided by a user or for requesting additional entries.

FIG. 13A illustrates a GUI 1312a rendered to draw attention to an add button 1315 and to instruct a user regarding adding new contacts after an onboarding process using the add button 1315. FIG. 13B illustrates a GUI 1312b rendered to display a user indicator 1318 and to request a photo of the user for the user indicator 1318. FIG. 13C illustrates a GUI 1312c rendered to display, in a list, entries without a photo. In this way, such an embodiment prompts a user to add photos for the entries in the GUI 1312c. According to an embodiment, photos may be used for rendering indicators of the entries. FIG. 13D illustrates a GUI 1312d rendered to display, in a list, entries without information regarding birthdays. In this way, such an embodiment prompts a user to add birthday information for entries in the GUI 1312d. Birthday information may be used to render notification indicators, e.g., the indicator 920a described hereinabove in relation to FIG. 9C.

In addition to receiving a manually entered indication of performing a task associated with a given entry, (e.g., an indication provided by a user through selection in a menu) embodiments may automatically identify/receive indications of occurrence of the performing entries/events. One such embodiment communicates with a software application, e.g., using an application programming interface, to determine that an event occurred. The software applications may include, for example, calling or messaging applications native to an electronic device or ecosystem implementing embodiments or a social media application. Embodiments may request permission from a user to communicate with the software applications. Records of occurrence for entries may be updated automatically responsive to automatically identifying or receiving indications that events occurred.

In some embodiments, a location of a user may be used to identify if any people associated with entries are located within a desired radius of the user. For example, if a given entry is a person, an embodiment will inform the user of the spatial proximity of the person with respect to the user. In further embodiments, a Geopin may be rendered in association with an indicator of the given entry to inform the user of the spatial proximity and/or a push notification may be used to notify the user.

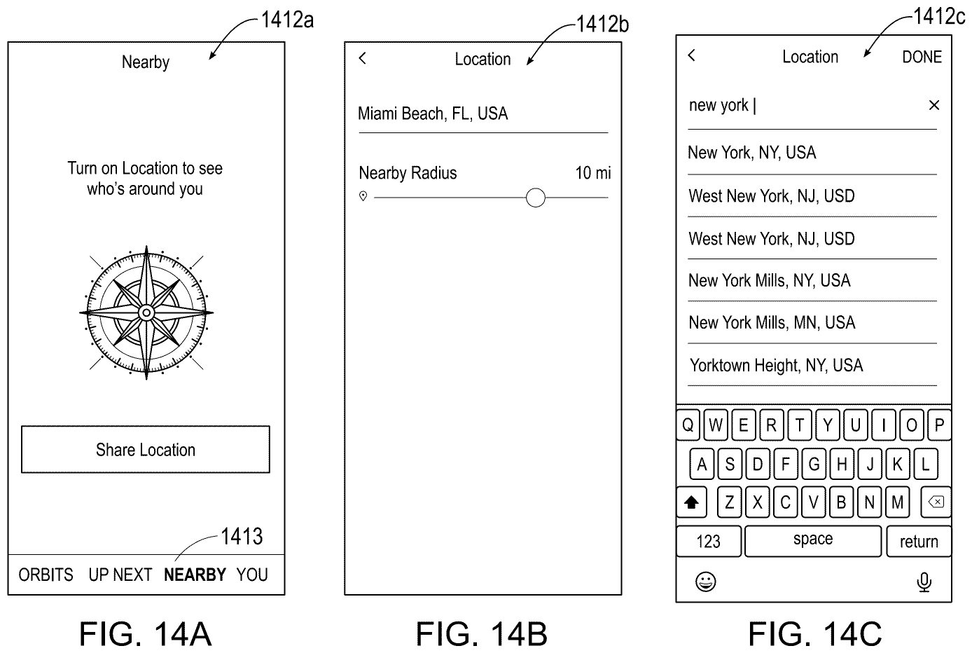

FIGS. 14A-C illustrate example GUIs 1412a, 1412b, 1412c, respectively, which may implemented by an embodiment for querying location information. FIG. 14A illustrates a GUI 1412a rendered to display a Nearby page, as indicated by a “NEARBY” tab selected on a tabulated menu 1413. The Nearby page may display indicators for entries within a desired spatial proximity to the user. The GUI 1412a indicates that location services of a device is not shared with the embodiment. As an alternative to automatically determining a location of the user using the locations services of the device, the location of the user may be manually entered. FIG. 14B illustrates a GUI 1412b rendered to allow a user to enter the user's location and the desired spatial proximity as a radial distance from the user. FIG. 14C illustrates a GUI 1412c rendered to further show a search function for manually entered locations.

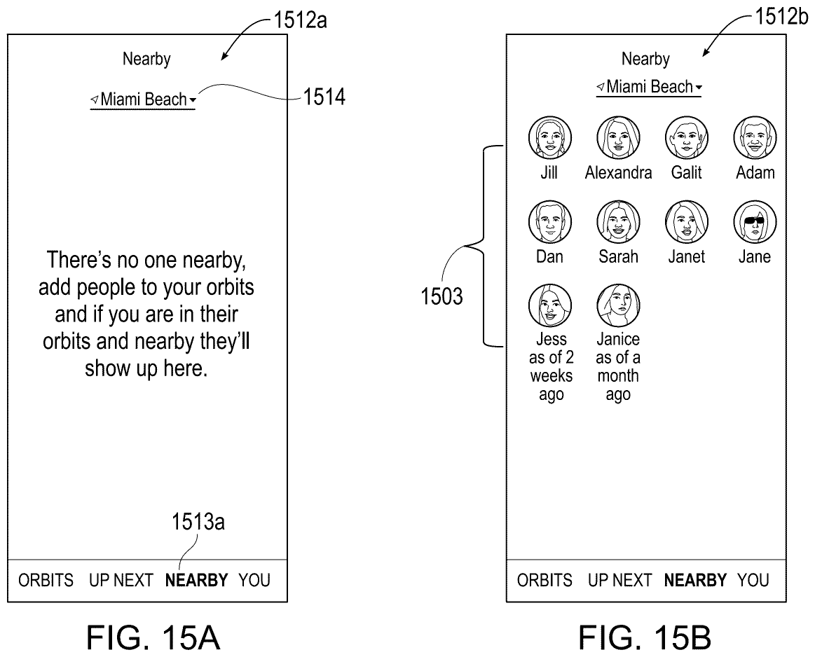

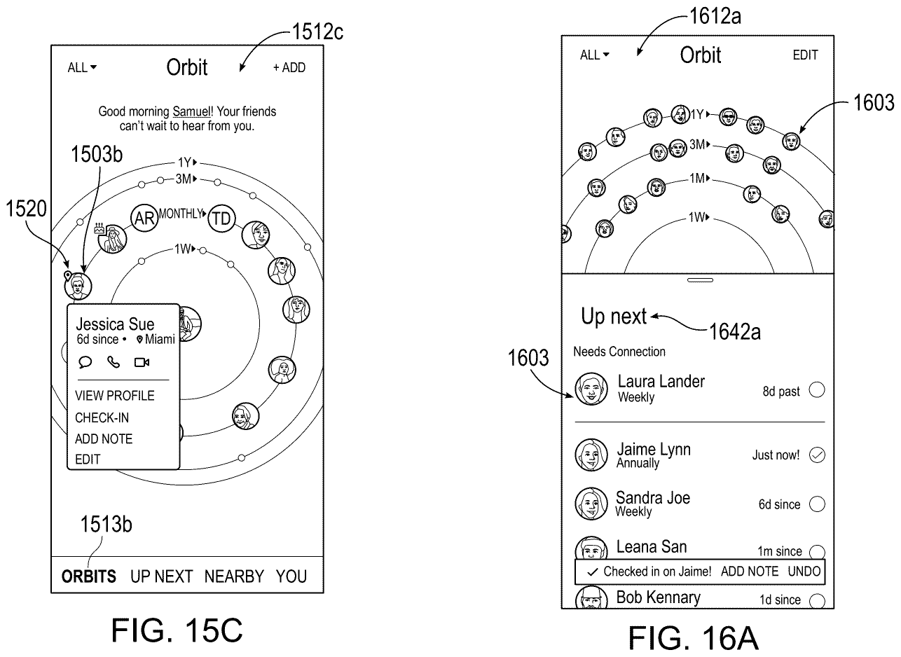

FIGS. 15A-15C illustrate example GUIs 1512a, 1512b, 1512c, respectively, indicating entries within a spatial proximity of a user based on the location information queried in FIGS. 14A-14C. According to an embodiment, the GUI 1412a as described hereinabove in relation to FIG. 14A is updated to the GUI 1512a or the GUI 1512b after receiving a location of a user. FIG. 15A illustrates a GUI 1512a rendered to show a Nearby page, as indicated by a “NEARBY” tab selected on a tabulated menu 1513a. The GUI 1512a includes a location 1514 and displays that no entries include location information within a spatial proximity of the user. FIG. 15B illustrates a GUI 1512b similar to the GUI 1512a, but wherein entries include location information within a spatial proximity of the user. The GUI 1512b further displays indicators 1503 corresponding to the entries within the spatial proximity.

FIG. 15C illustrates a GUI 1512c rendered to display an Orbits tab selected on a tabulated menu 1513b. The GUI 1512c includes a ring 1514 and indicators, e.g., 1503b. Furthermore, the GUI 1512c includes a notification indicator 1520 associated with the indicator 1503b to graphically indicate that an entry corresponding to the indicator 1503b includes location information within a spatial proximity to the user.

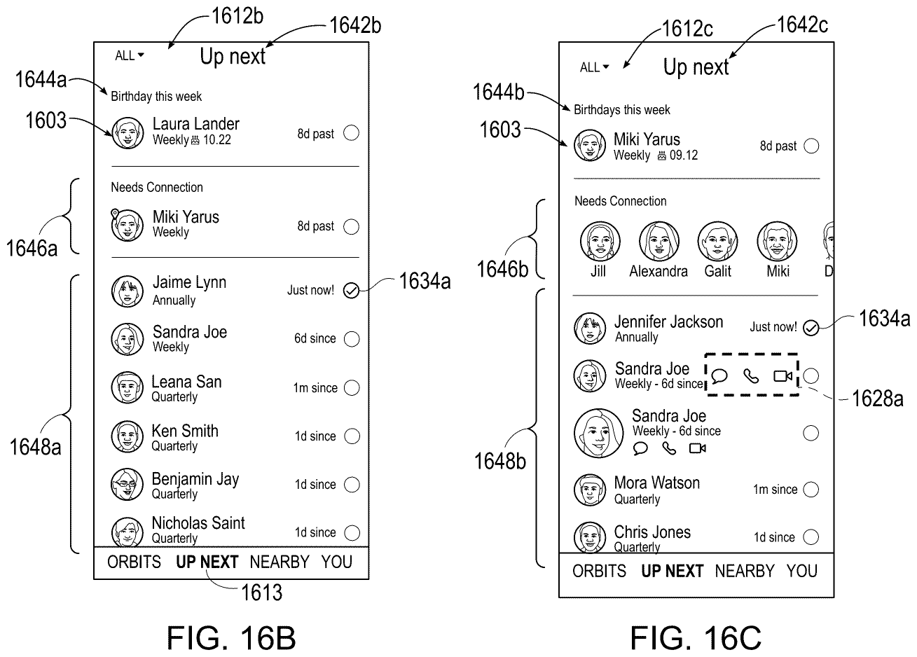

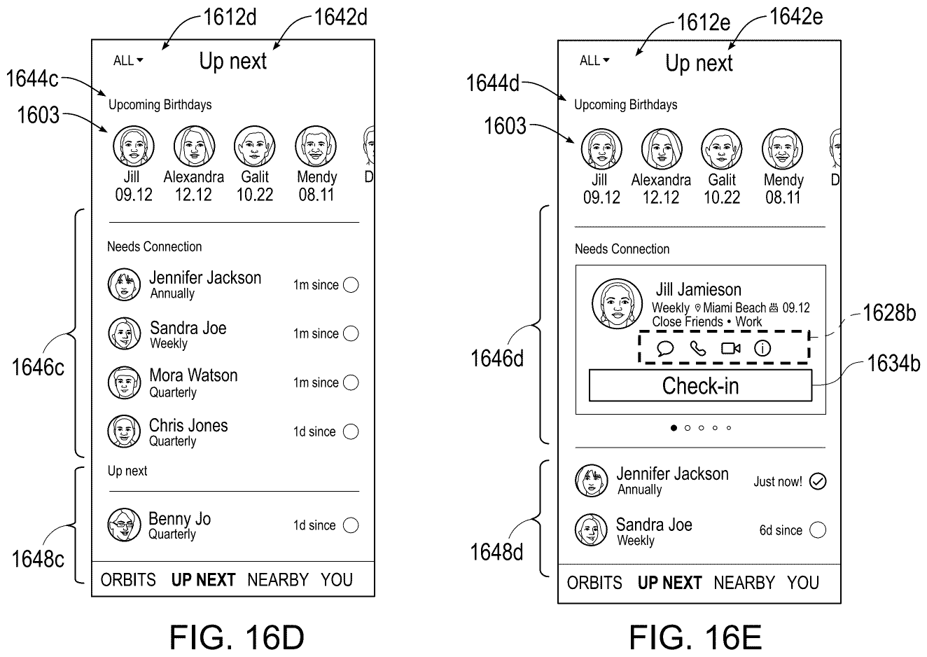

FIGS. 16A-16E illustrate example GUIs 1612a, 1612b, 1612c, 1612d, 1612e, respectively, which may be provided by an embodiment. Specifically, the GUIs 1612a-e render indicators for entries as a graphical list. While rendering of indicators for entries on at least one ring based on respective cadences and respective records of occurrences of the entries provides an intuitive interface for visualizing and tracking statuses of routine events, graphical lists may provide a simple interface for identifying imminent routine events. FIG. 16A illustrates a GUI 1612a rendered to display a graphical list 1642a of upcoming routine events as a draggable interface. An upcoming routine event or an imminent routine event may be a routine event for which an interaction is due in the near future, that is, a time elapsed since a record of occurrence for a given entry is approaching a cadence of the given entry. The GUI 1612a further displays indicators 1603 for a subset of a plurality of entries. In the graphical list 1642a, the indicators 1603 may be ordered, for example, chronologically ordered, based on time until an interaction is due.

FIG. 16B illustrates a GUI 1612b rendered to display a graphical list 1642b as an “Up next” page. Correspondingly, an “UP NEXT” tab is selected in the tabulated menu 1613. The GUI 1612b includes an upcoming birthdays list 1644a, a needs connection list 1646a, and an upcoming events list 1648a. The GUI 1612b further includes indicators, e.g., 1603 rendered for each entry in each list 1644a, 1646a, and 1648a. The needs connection list 1646a may include entries from a plurality of entries for which an interaction is overdue. The GUI 1612b may further display check-in buttons, e.g., 1634a, for manually recording a check-in with a given entry.

FIG. 16C illustrates a GUI 1612c rendered to display an alternative graphical list 1642c. Similar to the graphical list 1642a, the graphical list 1642c includes an upcoming birthdays list 1644b, a needs connection list 1646b, and an upcoming events list 1648b. The needs connection list 1646b is a carousel and configured to allow side scrolling. Additionally, the upcoming events list 1648b includes contact options 1628a to launch an interaction with a given entry and check-in buttons, e.g., 1634a, for manually recording a check-in with the given entry.

FIG. 16D illustrates a GUI 1612d rendered to display an alternative graphical list 1642d. The graphical list 1642d includes an upcoming birthday list 1644c as a carousel list, a needs connection list 1646c, and an upcoming events list 1648c. The list 1642d also includes indicators, e.g., 1603, associated with entries. FIG. 16E illustrates a GUI 1612e rendered to display an alternative graphical list 1642e, including an upcoming birthday list 1644d as a carousel list, a needs connection list 1646d as a carousel list, and an upcoming events list 1648d. The needs connection list 1646d further includes contact options 1628b and a check-in button 1634b.

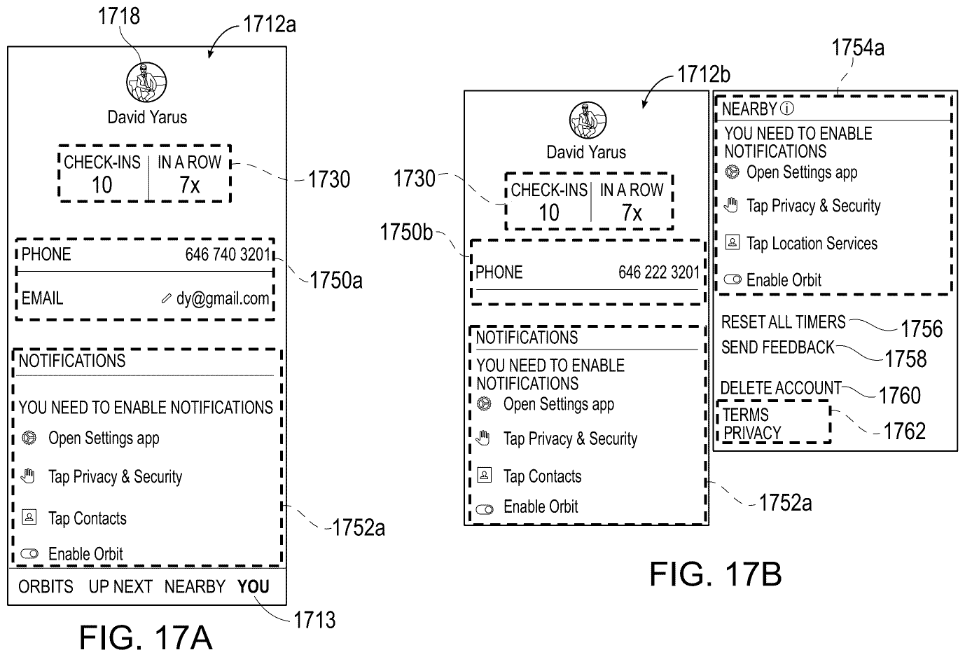

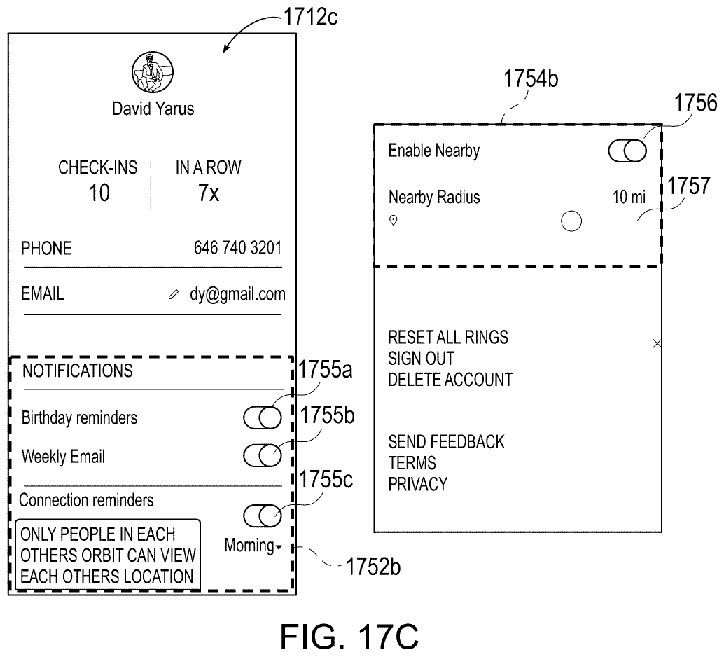

FIGS. 17A-17C illustrate example GUIs 1712a ,1712b, 1712c, respectively, which may be implemented by an embodiment to manage settings for a user. FIG. 17A illustrates a GUI 1712a for a settings page for the user. The settings page may be toggled by a “YOU” tab on the tabulated menu 1713 and may be rendered to display a portion of a total settings page based on a size of a graphical display on which the settings page is rendered. The settings page further includes a user indicator 1718, a counter 1730 of completed interactions with a plurality of entries, and user contact information 1750a of the user. The user contact information 1750a may have been provided during account creation, as described hereinabove in relation to FIGS. 3A and 3B. The GUI 1712a additionally displays a notification settings menu 1752a. The notification settings menu 1752a indicates that the embodiment has not received permissions to provide notifications to the user.

GUI 1712b of FIG. 17B is rendered to display an extended settings page, including elements similar to the GUI 1712a of FIG. 17A. The GUI 1712b includes the counter 1730, user contact information 1750b, and the notification settings menu 1752a. The GUI 1712b further includes a location settings menu 1754a, a timer reset button 1756, a feedback button 1758, an account deletion button 1760, and a terms and privacy button 1762. The location settings menu 1754a indicates that the embodiment has not received permissions to automatically identify a location of the user. The timer reset button 1756 may set respective records of occurrences of a plurality of entries to a present time. FIG. 17C illustrates a GUI 1712c rendered to display an extended settings page similar to that of the GUI 1712b, but where the embodiment has received permissions for providing notifications to the user and for automatically identifying the location of the user. Correspondingly, the GUI 1712c displays a notification settings menu 1752b including toggleable settings for notification types, e.g., birthday reminders 1755a, connection reminders 1755b, and weekly reminders emails 1755c. The GUI 1712c further displays a location settings menu 1754b including a toggle button 1756 for identifying entries of a plurality of entries within a spatial proximity of the user and a slider 1757 for indicating the spatial proximity desired.

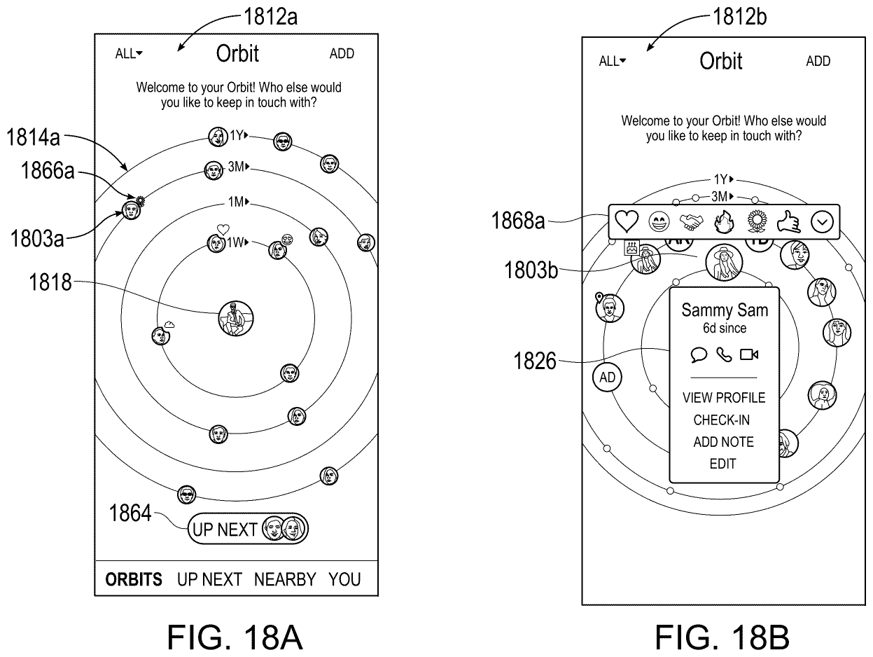

FIGS. 18A and 18B illustrate example GUIs 1812a, 1812b, respectively, which may be implemented by an embodiment, featuring functionality for communicating between a user and a given entry. FIG. 18A illustrates a GUI 1812a, which may be similar to the GUI 912a of FIG. 9A, rendered to display at least one ring, e.g., 1814a, indicators, e.g., 1803a, of a subset of a plurality of entries, and a user indicator 1818. The GUI 1812a further includes an “Up Next” menu button 1864 for opening a graphical list view, which may be similar to the GUIs 1612a-e of FIGS. 16A-16E. Additionally, the GUI 1812a includes reaction indicators, e.g., 1866a, rendered in association with indicators, e.g., 1803a. The reaction indicators, e.g., 1866a, provide functionality for communicating between a user and an entry. For example, in an embodiment, the given entry is a person, wherein the given entry using the embodiment selects a reaction indicator 1866a to express a message, e.g., a mood or a location. For the given entry, the GUI 1812a of the embodiment of the user renders the reaction indicator 1866a selected by the given entry in association with the indicator 1803a of the given entry. In this way, the person associated with the indicator 1803a can communicate with the user 1818. FIG. 18B illustrates a GUI 1812b rendered wherein a user is interacting with an indicator 1803b of a given entry of a plurality of entries. The GUI 1812b includes an entry menu 1826 and a reaction menu 1868a. The reaction menu 1868a may be used to apply a reaction indicator, for example, the reaction indicator 1866a, to the indicator 1803b to communicate with the given entry. In some embodiments, an individual entry selects a reaction indicator, e.g., 1866a, to communicate to users of embodiments, e.g., 1818. In other embodiments, the user, e.g., 1818, selects a reaction indicator, e.g., using the reaction menu 1868a, to communicate with the plurality of entries on a group or per-entry basis.

FIG. 19 is a flowchart of a method 1900 for generating visual representations of routine events according to an embodiment. The method 1900 comprises storing 1901 a plurality of entries (e.g., 102-1, 102-2, 102-n) in a data structure (e.g., 101) in computer memory. In turn, the method 1900 continues and renders 1903 a GUI (e.g., 112) based on the entries stored. Rendering 1903 the graphical user interface includes: (i) identifying 1905 a subset of the plurality of entries, (ii) rendering 1907 at least one ring (e.g., 114-1, 114-2) based on the subset identified, each ring of the at least one ring associated with a ring cadence, and (iii) rendering 1909 an indicator (e.g., 103-1, 103-2, 103-3, 103-4) of each entry of the subset on a ring of the at least one ring based on the ring cadence of the ring, the cadence of the entry, and the record of occurrence of the entry. A position of the indicator on the ring is a function of the record of occurrence and the cadence. The GUI rendered provides an intuitive interface for managing tasks, e.g., routine events, as described herein.

According to an embodiment, identifying 1905 a subset of the plurality of entries includes searching a data structure for entries with particular characteristics. For instance, a user may indicate that they want to see routine events that occur, e.g., weekly. In such an embodiment, the data structure storing the plurality of entries is searched for entries with a weekly cadence. In some embodiments, the particular characteristics include a relation to the subject (e.g., friend 505, best friends, family, or another relation) or a geographical location, and the data structure is searched for entries with a corresponding relation or geographical location. Such entries are thus identified 1905.

In some embodiments, the method 1900 further includes receiving a given entry of the plurality of entries from a user. For example, in some embodiments, the user may manually input information of a given entry (e.g., cadence 104, record of occurrence 106, and indicator 103). In other embodiments, the method 1900 includes retrieving automatically a given entry of the plurality of entries by communicating with a software applicating, e.g., using an application programming interface (API). For example, in some embodiments, contact information may be automatically retrieved from a native Contacts application on a computing device. In such embodiments, permission may be requested from the user to allow access to contacts (as illustrated in GUI 412b). The user may further then provide a relation (e.g., friends 505), a cadence (e.g., annually 504), and other information.

In some embodiments, the method 1900 further includes prompting a user to perform a given routine event based on the cadence and the record of occurrence included in a given entry of a plurality of entries. As illustrated in the GUI 612, permissions may be requested from a user to provide pop-up notifications to prompt the user. In such an embodiment, the given entry corresponds to the given event.

In some embodiments, the method 1900 includes receiving from a user an indication of an occurrence of a given event corresponding to a given entry of the subset of the plurality of entries. For example, this may include a manual check-in (e.g., check-in button 1634a, 1634b). The method 1900, according to such an embodiment, may further include updating the record of occurrence included in the given entry (e.g. updating the records of occurrence in a data structure). In further embodiments, the method 1900 includes modifying the position of the indicator for the given entry in the GUI based on the updated record of occurrence (e.g. the GUI 712e versus the GUI 712D). For instance, in some embodiments, the updated record of occurrence includes a time and a date of the occurrence of the given event.

In an embodiment, the method 1900 includes identifying automatically an indication of occurrence of a given event corresponding to a given entry of the subset of the plurality of entries by communicating with a software application, e.g., using an application programming interface. For instance, in some embodiments, the software application is a social media application or a native phone or text messages app. In some embodiments, a rendered GUI (e.g., 1212b) includes a contact options menu (e.g., 1228). In such embodiments, a user can initiate the occurrence of the given event within the rendered GUI. The record of occurrence included in the given entry may, in turn, be updated.

In some embodiments, the method 1900 includes identifying a delinquent entry of the plurality of entries based on the record of occurrence and the cadence included in the delinquent entry. The method 1900 may also render a visual marker, i.e., indication (e.g., 1023), for the delinquent entry in the GUI.

In some embodiments, the method 1900 includes rendering a graphical list (e.g., 1642a-e) based on the subset of the plurality of entries. An order of the subset of the plurality of entries in the graphical list may be a function of the record of occurrence and the cadence of each entry of the subset. In some embodiments, the graphical list may include one or more lists, e.g., an upcoming birthdays list 1644a-d or a needs connections list 1646a-d.

In other embodiments, the method 1900 includes rendering a symbol (e.g., 818) of a user within a circumference of the at least one ring. The symbol may include a photo of the user or an icon.

In some embodiments, the routine events include at least one of contacting an individual and performing an activity. According to some embodiments, for a given entry of the plurality of entries, the cadence included is a length of time. For example, cadences may include a weekly (e.g., 214a), monthly (e.g., 214b), quarterly (e.g., 214c), or annually (e.g., 214d) cadences.

In some embodiments, the at least one ring includes at least two rings (e.g., 214a-d). In such an embodiment, the rendering 1907 the at least one ring may include rendering a first ring of the at least two rings with a smaller radius to indicate a shorter ring cadence and rendering at least a second ring of the at least two rings to indicate a longer ring cadence. For instance, the first ring that represents a weekly interval (e.g., 214a) is smaller in circumference than the second ring that represents a monthly interval (e.g., 214b). In yet another embodiment, rendering 1907 the at least one ring includes rendering a first ring of the at least two rings and at least a second ring of the at least two rings concentrically (e.g., 214a-d).

In some embodiments, a given entry of the plurality of entries includes further information. For instance, in some embodiments, the additional information includes a relation, e.g., friend 505, to the user, a counter 1230 of occurrences of an event associated with the given entry, a history 1236 of the given entry, or notes entered by a user in a text box (e.g., 1232) associated with the given entry. According to an embodiment, the further information includes an entry location and such an embodiment includes retrieving automatically a location of a user by communicating with a software application, e.g., using an application programming interface. The method further 1900 includes notifying the user of a spatial proximity to the given entry based on the location of the user and the entry location of the given entry or rendering a graphic representation in the GUI of the spatial proximity. In such an embodiment, notifying the user includes rendering a spatial proximity indicator 920b or rendering a Nearby GUI 1512b including indicators 1503 of users in a spatial proximity of the user.

In yet another embodiment, the further information includes temporal information and the method 1900 includes notifying a user of a temporal proximity to the temporal information of the given entry based on a current date and the temporal information or providing a graphical representation of the temporal proximity. For instance, in some embodiments, the temporal information is a birthday and the graphical representation is a birthday indicator, e.g., cake 920a. In further embodiments, the temporal information includes an anniversary.

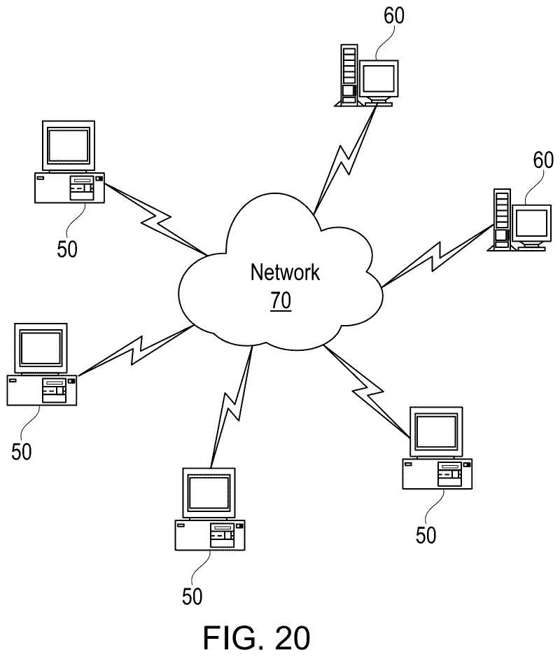

FIG. 20 illustrates a computer network or similar digital processing environment in which embodiments of the present disclosure may be implemented.

Client computer(s)/device(s) 50 and server computer(s) 60 provide processing, storage, and input/output devices executing application programs and the like. The client computer(s)/devices 50 can also be linked through communications network 70 to other computing devices, including other client computer(s)/device(s) 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computer(s)/device(s) 50 and/or server computer(s) 60 may be configured, alone or in combination, to implement the embodiments described herein, e.g., the method 1900, among other examples. The server computer(s) 60 may not be separate server computers but part of communications network 70.

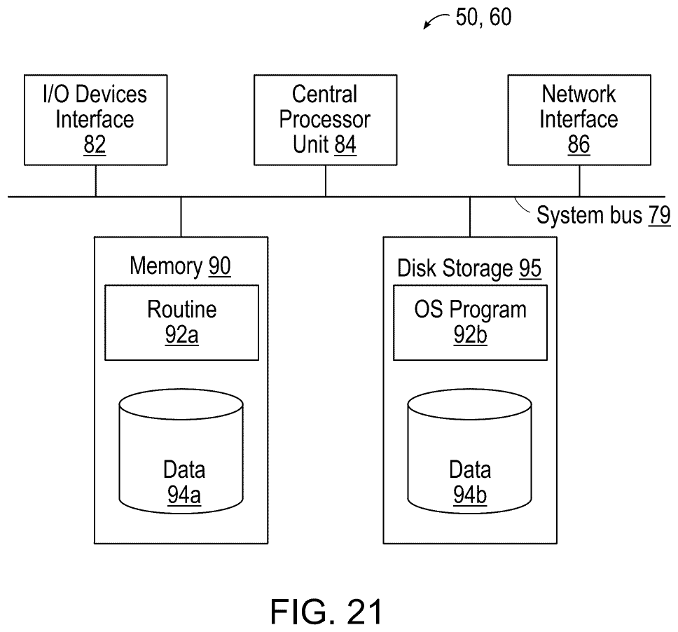

FIG. 21 is a diagram of an example internal structure of a computer (e.g., client computer(s)/device(s) 50 or server computer(s) 60) in the computer system of FIG. 20. Each computer/device 50 and server computer 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output (I/O) ports, network ports, etc.) and enables the transfer of information between the elements. Attached to the system bus 79 is an I/O devices interface 82 for connecting various input and output devices (e.g., keyboard, mouse, displays, printers, speakers, etc.) to the computer/device 50 or server computer 60. A network interface 86 allows the computer/device 50 or server computer 60 to connect to various other devices attached to a network (e.g., communications network 70 of FIG. 20). Memory 90 provides volatile storage for computer software instructions 92a and data 94a used to implement an embodiment of the present disclosure (e.g., the method 1900, among others). Disk storage 95 provides non-volatile storage for computer software instructions 92b and data 94b used to implement an embodiment of the present disclosure. A central processor unit 84 is also attached to the system bus 79 and provides for the execution of computer instructions.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method for generating visual representations of routine events, the method comprising:
storing a plurality of entries in a data structure in computer memory, each entry of the plurality of entries corresponding to a routine event and including a cadence and a record of occurrence; and
rendering a graphical user interface (GUI) based on the plurality of entries stored, wherein the rendering includes: (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry, wherein a position of the indicator on the ring is a function of the record of occurrence and the cadence and the rendering of the GUI provides a visual representation of routine events.

2. The computer-implemented method of claim 1, further comprising:
receiving a given entry of the plurality of entries from a user.

3. The computer-implemented method of claim 1, further comprising:
retrieving automatically a given entry of the plurality of entries by communicating with a software application using an application programming interface.

4. The computer-implemented method of claim 1, further comprising:
prompting a user to perform a given routine event based on cadence and record of occurrence included in a given entry of the plurality of entries corresponding to the given routine event.

5. The computer-implemented method of claim 1, further comprising:
receiving from a user an indication of occurrence of a given event corresponding to a given entry of the subset of the plurality of entries; and
updating the record of occurrence included in the given entry.

6. The computer-implemented method of claim 5, further comprising:
modifying the position of the indicator for the given entry in the GUI based on the record of occurrence updated.

7. The computer-implemented method of claim 1, further comprising:
identifying automatically an indication of occurrence of a given event corresponding to a given entry of the subset of the plurality of entries by communicating with a software application using an application programming interface; and
updating the record of occurrence included in the given entry.

8. The computer-implemented method of claim 1, further comprising:
identifying a delinquent entry of the plurality of entries based on the record of occurrence and the cadence included in the delinquent entry; and
rendering a visual marker for the delinquent entry in the GUI.

9. The computer-implemented method of claim 1, further comprising:
rendering a graphical list based on the subset of the plurality of entries, wherein an order of the subset of the plurality of entries in the graphical list is a function of the record of occurrence and the cadence of each entry of the subset.

10. The computer-implemented method of claim 1, further comprising:
rendering a symbol of a user within a circumference of the at least one ring.

11. The computer-implemented method of claim 1, wherein the routine events include at least one of:
contacting an individual and performing an activity.

12. The computer-implemented method of claim 1, wherein for a given entry of the plurality of entries the cadence included is a length of time.

13. The computer-implemented method of claim 1, wherein the at least one ring includes at least two rings.

14. The computer-implemented method of claim 13, wherein rendering the at least one ring includes rendering a first ring of the at least two rings with a smaller radius to indicate a shorter ring cadence and rendering at least a second ring of the at least two rings with a longer radius to indicate a longer ring cadence.

15. The computer-implemented method of claim 13, wherein rendering the at least one ring includes rendering a first ring of the at least two rings and at least a second ring of the at least two rings concentrically.

16. The computer-implemented method of claim 1, wherein a given entry of the plurality comprises further information.

17. The computer-implemented method of claim 16, wherein the further information includes an entry location and the method further comprises:
retrieving automatically a location of a user by communicating with a software application using an application programming interface; and
notifying the user of a spatial proximity to the given entry based on the location of the user and the entry location of the given entry or rendering a graphic representation in the GUI of the spatial proximity.

18. The computer-implemented method of claim 16, wherein the further information includes temporal information and the method further comprises:
notifying a user of a temporal proximity to the temporal information of the given entry based on a current date and the temporal information or providing a graphical representation of the temporal proximity.

19. A computer-based system for generating visual representations of routine events, the system comprising:
a display;
a processor; and
a memory with computer code instructions stored thereon, the processor and the memory, with the computer code instructions, being configured to cause the computer-based system to:
store a plurality of entries in a data structure in the memory, each entry of the plurality of entries corresponding to a routine event and including a cadence and a record of occurrence; and
render, on the display, a graphical user interface (GUI) based on the plurality of entries, wherein the rendering includes: (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry, wherein a position of the indicator on the ring is a function of the record of occurrence and the cadence, and the rendering of the GUI provides a visual representation of routine events.

20. A computer program product for generating visual representations of routine events, the computer program product comprising a non-transitory computer-readable medium with computer code instructions stored thereon, the computer code instructions configured, when executed by a processor, to cause an apparatus associated with the processor to:
store a plurality of entries in a data structure in the memory, each entry of the plurality of entries corresponding to a routine event and including a cadence and a record of occurrence; and
render, on the display, a graphical user interface (GUI) based on the plurality of entries, wherein the rendering includes: (i) identifying a subset of the plurality of entries, (ii) rendering at least one ring based on the subset identified, each ring of the at least one ring associated with a ring cadence, and (iii) rendering an indicator for each entry of the subset on a ring of the at least one ring based on the ring cadence of the ring, the cadence of the entry, and the record of occurrence of the entry, wherein a position of the indicator on the ring is a function of the record of occurrence and the cadence, and the rendering of the GUI provides a visual representation of routine events.
